(19) United States
(12) Patent Application Publication
(10) Pub. No.: US 2016/0066320 A1
(43) Pub. Date: Mar. 3, 2016

(54) DEDICATED SINGLE STREAM PILOTS FOR UPLINK MULTI-USER MIMO

(71) Applicant: QUALCOMM Incorporated, San Diego, CA (US)

(72) Inventors: Lin YANG, San Diego, CA (US); Dung Ngoc DOAN, San Diego, CA (US); Tao TIAN, San Diego, CA (US); Bin TIAN, San Diego, CA (US); Sameer VERMANI, San Diego, CA (US); Rahul TANDRA, San Diego, CA (US)

(21) Appl. No.: 14/842,750

(22) Filed: Sep. 1, 2015

Related U.S. Application Data
(60) Provisional application No. 62/044,879, filed on Sep. 2, 2014.

(51) Int. Cl. H04W 72/04; H04L 5/00; H04L 27/26; H04B 7/04

(52) U.S. Cl. CPC H04W 72/0446; H04B 7/0452; H04L 5/0048; H04L 27/2601; H04W 88/08

(57) ABSTRACT

A method, an apparatus, and a computer-readable medium for wireless communication are provided. In one aspect, an apparatus allocates dedicated sets of pilot tones within symbols to a plurality of stations to enable per station phase drift tracking from symbol to symbol. Each station of the plurality of stations is allocated a dedicated set of pilot tones for transmitting dedicated single stream pilots to enable the apparatus to perform per station phase drift tracking from symbol to symbol. The apparatus transmits a frame to the plurality of stations. The frame includes information indicating the allocated and dedicated sets of pilot tones used for transmitting dedicated single stream pilots to enable per station phase drift tracking from symbol to symbol.

### CROSS-REFERENCE TO RELATED APPLICATION(S)

This application claims the benefit of U.S. Provisional Application Ser. No. 62/044,879, entitled “Dedicated Single Stream Pilots for Uplink Multi-User MIMO” and filed on Sep. 2, 2014, which is expressly incorporated by reference herein in its entirety.

### BACKGROUND

1. Field

The present disclosure relates generally to communication systems, and more particularly, to using dedicated single stream pilots for uplink multi-user (MU) multiple-input multiple-output (MIMO).

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer program products, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., an access point) for wireless communication. The wireless device is configured to allocate dedicated sets of pilot tones to a plurality of stations to enable per station phase drift tracking from symbol to symbol. Each station of the plurality of stations is allocated a dedicated set of pilot tones and each dedicated set of pilot tones is used to transmit dedicated single stream pilots. The wireless device is further configured to transmit a frame to the plurality of stations, in which the frame includes information indicating the allocated and dedicated set of pilot tones used for transmitting dedicated single stream pilots.

Another aspect of the disclosure provides an apparatus for wireless communication. The apparatus includes means for allocating dedicated sets of pilot tones to a plurality of stations to enable per station phase drift tracking from symbol to symbol. Each station of the plurality of stations may be allocated a dedicated set of pilot tones and each dedicated set of pilot tones may be used to transmit dedicated single stream pilots. The apparatus includes means for transmitting a frame to the plurality of stations. The frame may include information indicating the allocated and dedicated sets of pilot tones used for transmitting dedicated single stream pilots. In an aspect, the frame may further include information indicating an order in which each station of the plurality of stations has been allocated the dedicated sets of pilot tones. In another configuration, the apparatus may include means for receiving a plurality of dedicated single stream pilots from the plurality of stations. In this configuration, the apparatus may include means for determining a phase drift for each station of the plurality of stations based on the received plurality of dedicated single stream pilots. In another configuration, the means for receiving may be configured to receive, from each station, a first and a second dedicated single stream pilots located on a first symbol and a third and a fourth dedicated single stream pilots located on a second symbol. In this configuration, the means for determining the phase drift may be configured to, for each station of the plurality of stations, determine a first difference between a first phase of the first dedicated single stream pilot located on the first symbol and a second phase of the third dedicated single stream pilot located on the second symbol. The means for determining may be configured to determine, for each station of the plurality of stations, a second difference between a third phase of the second dedicated single stream pilot located on the first symbol and a fourth phase of the fourth dedicated single stream pilot located on the second symbol. For each station of the plurality of stations, the means for determining may be configured to average the first difference and the second difference. In an aspect, the dedicated sets of pilot tones may be located within at least one of a set of long training field symbols or a set data symbols. In another aspect, each dedicated set of pilot tones may have at least two pilot tones allocated to each station of the plurality of stations. In another aspect, each station of the plurality of stations may have a fixed number of allocated pilot tones within a symbol. In another aspect, each station of the plurality of stations may have a same number of allocated pilot tones in a period. In another aspect, each dedicated set of pilot tones may have two pilot tones allocated to each station of the plurality of stations, and the means for allocating the dedicated sets of pilot tones may be configured to reserve a number of pilot tones for the plurality of stations, and the number may be at least twice a total number of stations in the plurality of stations.

Another aspect of the disclosure provides a computer-readable medium storing computer executable code for wireless communication. The computer-readable medium may include code for allocating dedicated sets of pilot tones to a plurality of stations to enable per station phase drift tracking from symbol to symbol. Each station of the plurality of stations may be allocated a dedicated set of pilot tones and each dedicated set of pilot tones may be used to transmit dedicated single stream pilots. The computer-readable medium may include code for transmitting a frame to the plurality of stations. The frame may include information indicating the allocated and dedicated sets of pilot tones used for transmitting dedicated single stream pilots. In another aspect, the frame may further include information indicating an order in which each station of the plurality of stations has been allocated the dedicated sets of pilot tones. In another configuration, the computer-readable medium may include code for receiving a plurality of dedicated single stream pilots from the plurality of stations and for determining a phase drift for each station of the plurality of stations based on the received plurality of dedicated single stream pilots. In this configuration, the code for receiving may include code for receiving, from each station, a first and a second dedicated single stream pilots located on a first symbol and a third and a fourth dedicated single stream pilots located on a second symbol. In this configuration, the code for determining the phase drift may include, code for determining, for each station of the plurality of stations, a first difference between a first phase of the first dedicated single stream pilot located on the first symbol and a second phase of the third dedicated single stream pilot located on the second symbol, for determining, for each station of the plurality of stations, a second difference between a third phase of the second dedicated single stream pilot located on the first symbol and a fourth phase of the fourth dedicated single stream pilot located on the second symbol, and for averaging, for each station of the plurality of stations, the first difference and the second difference. In another aspect, the dedicated sets of pilot tones may be located within at least one of a set of long training field symbols or a set data symbols. In another aspect, each dedicated set of pilot tones may have at least two pilot tones allocated to each station of the plurality of stations. In another aspect, each station of the plurality of stations may have a fixed number of allocated pilot tones within a symbol. In another aspect, each station of the plurality of stations may have a same number of allocated pilot tones in a period. In another configuration, each dedicated set of pilot tones may have two pilot tones allocated to each station of the plurality of stations, and the code for allocating the dedicated sets of pilot tones may include code for reserving a number of pilot tones for the plurality of stations, in which the number is at least twice a total number of stations in the plurality of stations.

Another aspect of this disclosure provides a wireless device (e.g., a station) for wireless communication. The wireless device is configured to receive a frame from an access point. The frame received from the access point includes information that indicates a dedicated set of allocated pilot tones for the wireless device to enable phase drift tracking from symbol to symbol. The wireless device is further configured to transmit to the access point dedicated single stream pilots on the dedicate set of allocated pilot tones based on the information.

Another aspect of the disclosure provides an apparatus for wireless communication. The apparatus includes means for receiving a frame from an access point. The frame may include information that indicates a dedicated set of pilot tones allocated to the apparatus to enable phase drift tracking from symbol to symbol. The apparatus includes means for transmitting to the access point dedicated single stream pilots on the dedicated set of pilot tones based on the information. In an aspect, the dedicated set of pilot tones may be located within at least one of a set of long training field symbols or a set of data symbols. In another aspect, the frame may further include information indicating an order in which the apparatus has been allocated the dedicated set of pilot tones. In another configuration, the apparatus may include means for determining the dedicated set of pilot tones allocated to the apparatus based on the information included in the frame. In another aspect, the dedicated set of pilot tones may include at least two pilot tones. In another aspect, the apparatus may be allocated a fixed number of pilot tones within a symbol.

Another aspect of the disclosure provides a computer-readable medium storing computer executable code for wireless communication. The computer-readable medium may include code for receiving a frame from an access point. The frame may include information that indicates a dedicated set of pilot tones allocated to the apparatus to enable phase drift tracking from symbol to symbol. The computer-readable medium may include code for transmitting to the access point dedicated single stream pilots on the dedicated set of pilot tones based on the information. In an aspect, the dedicated set of pilot tones may be located within at least one of a set of long training field symbols or a set of data symbols. In another aspect, the frame may further include information indicating an order in which the apparatus has been allocated the dedicated set of pilot tones. In another configuration, the computer-readable medium may include code for determining the dedicated set of pilot tones allocated to the apparatus based on the information included in the frame. In another aspect, the dedicated set of pilot tones may include at least two pilot tones.

In another aspect, the apparatus may be allocated a fixed number of pilot tones within a symbol.

### BRIEF DESCRIPTION OF THE DRAWINGS

FIG. 1 shows an example wireless communication system in which aspects of the present disclosure may be employed.

FIG. 2 is an exemplary diagram of a method for allocating dedicated single stream pilot tones and for transmitting dedicated single stream pilots in a wireless network.

FIGS. 3A-3C are diagrams for allocating dedicated single stream pilot tones.

FIG. 4 is a diagram for allocating dedicated single stream pilot tones.

FIG. 5 is a functional block diagram of a wireless device that may be employed within the wireless communication system of FIG. 1 to allocate dedicated single stream pilots for phase tracking.

FIG. 6 is a flowchart of an exemplary method of wireless communication for dedicated single stream pilot allocation and phase tracking.

FIG. 7 is a functional block diagram of an exemplary wireless communication device for dedicated single stream pilot allocation and phase tracking.

FIG. 8 is a functional block diagram of a wireless device that may be employed within the wireless communication system of FIG. 1 for transmitting dedicated single stream pilot for phase tracking.

FIG. 9 is a flowchart of an example method of wireless communication for transmitting dedicated single stream pilot for phase tracking.

FIG. 10 is a functional block diagram of an exemplary wireless communication device for transmitting dedicated single stream pilot for phase tracking.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB,

Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams, and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

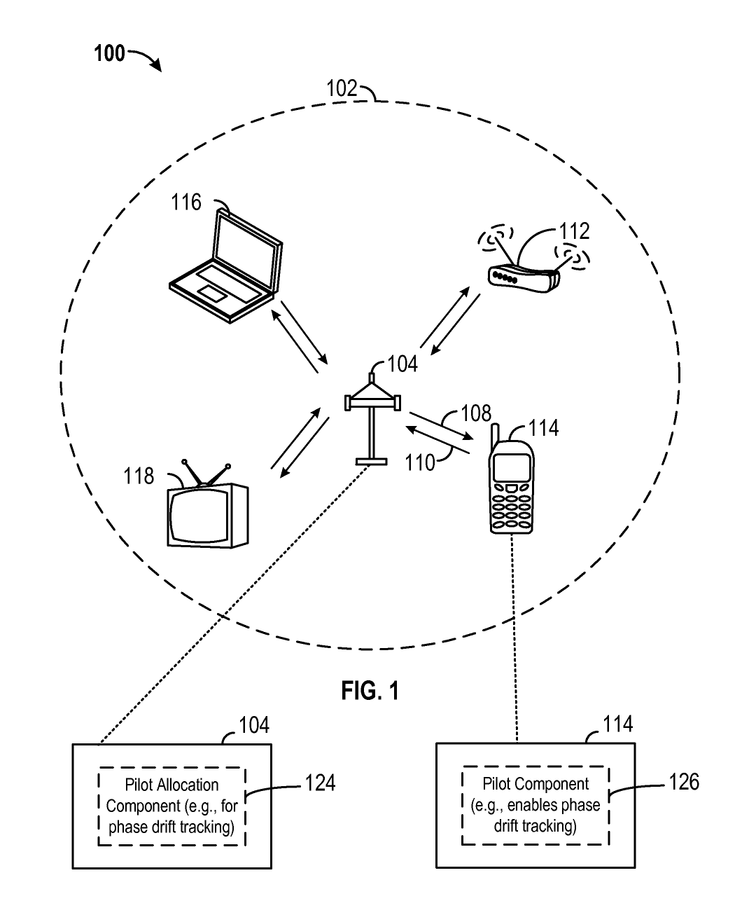

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. For example, the AP 104 may include a pilot allocation component 124 configured to perform procedures related to tracking a phase drift in received symbols (long training field symbols and/or data symbols) from stations. In this example, the pilot allocation component 124 may be configured to allocate dedicated sets of pilot tones a plurality of stations (e.g. STAs 112, 114, 116, 118) to enable per user phase drift tracking from symbol to symbol. Each station (e.g., STA 114) of the plurality of stations may be allocated a dedicated set of pilot tones, and each dedicated set of pilot tones may be used to transmit dedicated single stream pilots. The pilot allocation component 124 may be configured to transmit a frame to the plurality of stations, and the frame may include information indicating the allocated and dedicated sets of pilot tones used for transmitting dedicated single stream pilots.

In another aspect, the STA 114 may include one or more components for performing various functions. For example, the STA 114 may include a pilot component 126 configured to perform procedures related to receiving pilot tone allocations and transmitting dedicated single stream pilots based on the received pilot tone allocations. In this example, the pilot component 126 may be configured to receive a frame from the AP 104. The frame may include information that indicates a dedicated set of allocated pilot tones for the STA 114 to be used for phase drift tracking from symbol to symbol (or over symbols). The pilot component 126 may be configured to transmit to the AP 104 dedicated single stream pilots on the dedicated set of allocated pilot tones based on the information.

In wireless networks, a signal travels through a medium called a channel, which may distort and add noise to the signal. To properly decode a received signal, any distortion or noise added by the channel may be removed by determining the characteristics of the channel. The process of determining the characteristics of a channel is called channel estimation. To perform channel estimation, a mathematical model may be used to correlate a transmitted signal, x(t), with a received signal, y(t). The transmitted signal x(t) may be a known signal (e.g., a reference signal or a pilot signal). The received signal, y(t), is not the same as the transmitted signal, x(t), because the signal x(t) may be subjected to distortion and noise while being transmitted through the channel. The relationship between the transmitted signal and the received signal may be expressed as y(t)=x(t)H+n, where H represents the channel matrix and n represents the noise. By comparing the transmitted signal x(t) with the received signal y(t), the channel matrix H may be determined.

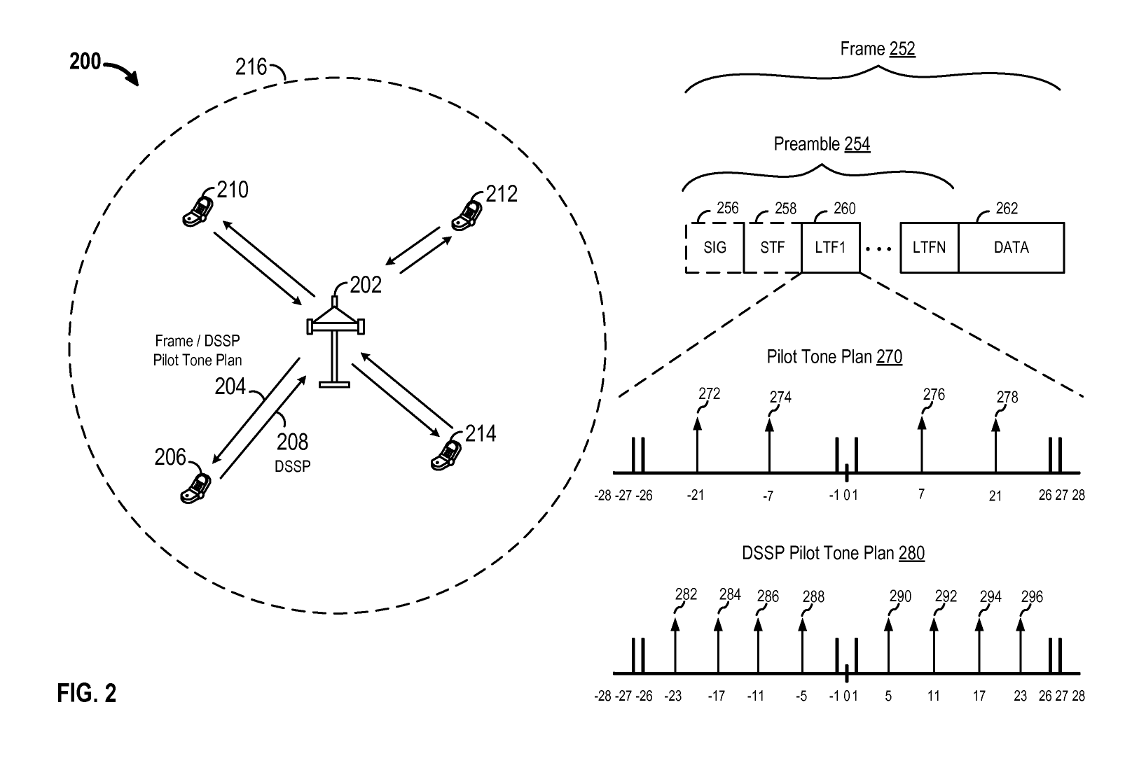

In Wi-Fi networks, long training field (LTF) symbols within a frame, as shown in FIG. 2 infra, may be used for channel estimation. However, LTF symbols (and other symbols) may experience phase drift from one LTF symbol to another LTF symbol, especially when the LTF symbols have a long symbol duration or when there are a large number of LTF symbols (e.g., greater than 4 LTF symbols). Phase drift and channel estimation are different. Channel estimation, as described above, is a determination of a channel's characteristics. Phase drift may be separate from channel estimation and may correspond to the change in phase from one symbol to another symbol. Phase drifts from one LTF symbol to another LTF symbol may affect the accuracy of the channel estimation. Phase drift from one data symbol to another data symbol may affect the accuracy of the retrieved data in the data symbols. In Wi-Fi networks that implement multi-user MIMO, dedicated single stream pilots may be used to track per user phase drift in received LTF symbols for better channel estimation when the number of LTF symbols is greater than 4. Single stream pilots may also be applied to data symbols. Current wireless networks (e.g., IEEE 802.11ac) may perform downlink multi-user MIMO in which an AP may transmit signals for multiple STAs. In downlink multi-user MIMO, all phase offsets are from the same source (e.g., the AP), and the phase offsets become a common offset among different STAs. As a result, only one set of single stream pilots is needed to track this common phase. In other wireless networks, uplink multi-user MIMO may be employed. In uplink multi-user MIMO, multiple STAs may transmit to an AP. For example, an AP may schedule a transmission, and each STA may send out packets individually, so the phase drift, mainly a result of timing error and frequency offset, may be different for each STA. To accurately receive the packets (and perform channel estimation), the phase shift should be accounted for on a per user basis. A need exists for per user phase tracking for per user channel estimation in uplink multi-user MIMO because each user has an individual timing offset and frequency offset. Additionally, in certain wireless networks, the symbol duration may be longer, thereby requiring a longer time duration. The phase drift value for a symbol may linearly increase with time, so the longer the symbol duration, the larger the phase offset, and the more significant the impact on performance. One method of performing per user phase tracking is using dedicated single stream pilots (DSSPs). In an aspect, if multiple spatial streams are transmitted, DSSPs may only be transmitted on the first spatial stream. In one aspect, each STA may be allocated a dedicated single stream pilot tone, different from another STA's dedicated single stream pilot tone, on which to transmit a dedicated single stream pilot. If each STA (or user) is allocated a different set of pilot tones, then per user phase tracking can be performed as further discussed below.

FIG. 2 is an exemplary diagram 200 of a method for allocating dedicated single stream pilot tones and for transmitting dedicated single stream pilots in a wireless network (e.g., a Wi-Fi network). The diagram 200 illustrates an AP 202 broadcasting/transmitting within a service area 216. STAs 206, 210, 212, 214 are within the service area 216 of the AP 202 (although only four STAs are shown in FIG. 2, more or less STAs may be within the service area 216).

In the uplink, the STA 206, for example, may transmit packets to the AP 202 in the form of a frame 252. The frame 252 may include a preamble 254 and data symbols 262. The preamble 254 may be considered a header of the frame 252 with information identifying a modulation scheme, a transmission rate, and a length of time to transmit the frame 252. The preamble 254 may include a signal (SIG) field 256, a short training field (STF) 258, and one or more long training field (LTF) symbols 260 (e.g., LTF1, LTF2, . . . , LTFN). The SIG field 256 may be used to transfer rate and length information. The STF 258 may be used to improve automatic gain control (AGC) in a multi-transmit and multi-receive system. The LTF symbols 260 provides the information needed for a receiver (e.g., the AP 202) to perform channel estimation. The number of LTF symbols may be equal or greater than the number of space-time streams from different STAs. For example, if there are 4 STAs, there may be 4 LTF symbols (i.e. LTF1, LTF2, LTF3, LTF4). The data symbols 262 contain the data to be communicated between the STA 206, for example, and the AP 202.

In one aspect, due to phase drift, the LTF symbols 260 transmitted by the STAs 206, 210, 212, 214 to the AP 202 may not be orthogonal (the same may be true of data symbols transmitted by the STAs to the AP 202). This would adversely impact per STA (or per user) channel estimation (which is separate from phase drift determination). To estimate phase drift in the LTF symbols 260 for each of the STAs 206, 210, 212, 214, the AP 202 may allocate dedicated sets of pilot tones to each of the STAs 206, 210, 212, 214.

In one aspect, the LTF symbols 260 may have a pilot tone plan 270. Generally, a symbol may include data to be communicated. When a symbol is transmitted, the symbol may be subject to phase drifts, for example, which may affect the ability of the symbol to be accurately decoded. Pilots may be transmitted within the symbol for purposes of phase and frequency tracking and training By transmitting pilots within symbols, a phase drift for a symbol may be compensated. Pilots may be values known to the receiver, and the pilot values for each pilot may be identical. Because the number of pilots and the location in which a pilot is transmitted within a symbol may affect the accuracy of any corrections, a pilot tone plan may indicate the tone index in which a pilot may be transmitted (e.g., where in the symbol a pilot is to be transmitted) and the number of pilots to be transmitted.

Referring to FIG. 2, the pilot tone plan 270 corresponds to a 64-point Fast Fourier Transform (FFT) that can be used with a 20 megahertz (MHz) symbol (e.g., High Efficiency LTF symbol) having a 1 symbol duration (e.g., 3.2 μs). The 64-point FFT has 4 pilot tones 272, 274, 276, 278 located at tone indices −21, −7, 7, 21, respectively. In this aspect, each of the pilot tones 272, 274, 276, 278 may be allocated to each of the STAs 206, 210, 212, 214. The pilot tone 272 may be allocated to STA 206, the pilot tone 274 may be allocated to the STA 210, the pilot tone 276 may be allocated to the STA 212, and the pilot tone 278 may be allocated to the STA 214. When a pilot tone may only be allocated to a particular STA, the pilot tone is a dedicated pilot tone. In this case, having only one pilot tone, however, may not be enough to perform phase drift estimation. In one configuration, at least two pilot tones may be allocated per STA. Because the pilot tone plan 270 is limited to only 4 pilot tones, however, additional pilot tones may be reserved. In another configuration, each STA may have a fixed number of allocated pilot tones within a symbol.

A DSSP pilot tone plan 280 illustrates that additional pilot tones may be inserted into the pilot tone plan 270. Assuming the STAs 206, 210, 212, 214 are supported by the AP 202, and each STA is allocated 2 pilot tones each within each of the LTF symbols 260 (e.g., LTF1, LTF2, LTF3, LTF4), then 8 dedicated pilot tones are needed to support all 4 STAs 206, 210, 212, 214. In the DSSP pilot tone plan 280, because there are already 4 existing pilot tones based on the pilot tone plan 270, 4 more pilot tones may be added. As shown in the DSSP pilot tone plan 280, there are 8 dedicated pilot tones 282, 284, 286, 288, 290, 292, 294, 296. In an aspect, the set of pilot tones 282, 290 may be allocated to the STA 206 and may be dedicated to the STA 206, the set of pilot tones 284, 292 may be allocated to the STA 210 and may be dedicated to the STA 210, the set of pilot tones 286, 294 may be allocated to the STA 212 and may be dedicated to the STA 212, and the set of pilot tones 288, 296 may be allocated to the STA 214 and may be dedicated to the STA 214. Having allocated the dedicated sets of pilot tones to each of the STAs 206, 210, 212, 214, the AP 202 may transmit information indicating the allocated and dedicated sets of pilot tones in a frame 204 to the STAs 206, 210, 212, 214. In addition to the allocation information, the frame 204 may include information indicating an order in which each of the STAs 206, 210, 212, 214 has been allocated the dedicated sets of pilot tones (e.g., pilot tones 282, 290 (set one), pilot tones 284, 292 (set two), pilot tones 286, 294 (set three), and pilot tones 288, 296 (set four)). For example, the information may indicate that the STA 206 has been allocated the first dedicated set of pilot tones corresponding to pilot tones 282, 290 among four dedicated sets of pilot tones. Although FIG. 2 only illustrates the pilot tone positions corresponding to LTF1, subsequent LTF symbols (e.g., LTF2, . . . , LTFN) may have the same corresponding pilot tone positions.

Once the STA 206, for example, receives the frame 204 from the AP 202, the STA 206 may determine that pilot tones 282, 284, 286, 288, 290, 292, 294, 296 have been allocated to STAs 206, 210, 212, 214. The STA 206 may determine, based on ordering information received from the frame 204, that the AP 202 has allocated the first dedicated set of pilot tones to the STA 206, and the first dedicated set of pilot tones corresponds to pilot tones 282, 290. In one aspect, the STA 206 may determine which dedicated sets of pilots have been allocated to the STAs 210, 212, 214. In one configuration, the dedicated set of pilot tones 282, 290 allocated to the STA 206 are located in the LTF symbols 260 for estimating phase drift in the LTF symbols 260 transmitted by the STA 206. In another configuration, the dedicated set of pilot tones 282, 290 may be located in the data symbols 262 for estimating phase drift in the data symbols 262. Having determined the dedicated set of pilot tones allocated to the STA 206, the STA 206 may transmit to the AP 202 dedicated single stream pilots 208 on the dedicated set of pilot tones 282, 290 in the LTF symbols 260 or the data symbols 262.

The AP 202 may receive the dedicated single stream pilots 208 from the STA 206 and the other STAs 210, 212, 214. The AP 202 may determine a phase drift for each of the STAs 206, 210, 212, 214 based on the received dedicated single stream pilots. For LTF symbols, phase drift tracking may be performed during channel estimation (e.g., determining the channel matrix H). For data symbols, phase drift tracking for data symbols may be performed after channel estimation. However, for both LTF symbols and data symbols, performing phase drift tracking is different from performing channel estimation.

In one aspect, the AP 202 may determine the phase drift for each of the STAs 206, 210, 212, 214 by comparing a first phase of a first dedicated single stream pilot located on a first symbol with a second phase of a second dedicated single stream pilot located on a second symbol. In one example, after the STA 206 transmits DSSPs on the dedicated set of pilot tones 282, 290 located on the LTF symbols 260 (e.g., LTF1 and LTF2), the AP 202 may compare a phase of a pilot transmitted on the pilot tone 282 on LTF1 with a phase of a pilot transmitted on the pilot tone 282 on LTF2. By determining the difference between both phases, the AP 202 may determine the LTF phase drift for STA 206. In another example, after the STA 206 transmits DSSPs on the dedicated set of pilot tones 282, 290 located on the LTF symbols 260 (e.g., LTF1 and LTF2), the AP 202 may receive from the STA 206 DSSPs located on pilot tones 282, 290 on the LTF1 and DSSPs located on pilot tones 282, 290 on the LTF2. The AP 202 may determine a first phase difference between a DSSP transmitted on the pilot tone 282 located on the LTF1 and a DSSP transmitted on the pilot tone 282 located on the LTF2. The AP 202 may determine a second phase difference between a DSSP transmitted on the pilot tone 290 located on LTF1 and a DSSP transmitted on pilot tone 290 located on LTF2. Subsequently, the AP 202 may average the first and second phase differences to estimate a phase drift for the STA 206. This method may also be performed in data symbols 262 to determine a phase drift in the data symbols 262.

Although the discussion thus far has been with respect to a tone plan that supports 4 STAs, additional STAs may be supported. For example, if 8 STAs are supported with 2 pilots each, then 12 pilot tones may be added to the pilot tone plan 270. In one aspect, the pilot tones for each user may be spread evenly over the full bandwidth. The pilot tones may be on tones that belong to the STA. The pilot tones may be in the middle of two LTF tones belonging to the same STA.

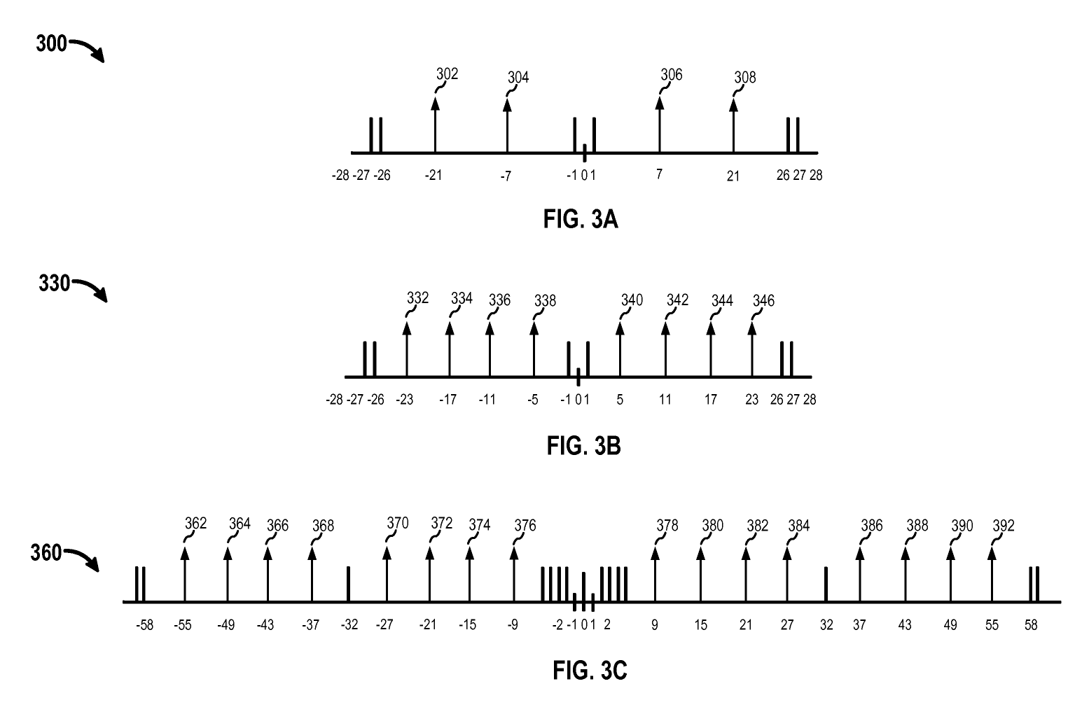

In another configuration, a 128-point FFT that can be used with a 20 MHz symbol (e.g., High Efficiency LTF symbol) having a 2 symbol duration (e.g., 6.4 μs) or a 40 MHz symbol having a 1 symbol duration. In this configuration, if 4 STAs are to be supported with 2 pilots each, the pilot tone plan (on the LTF symbols 260, for example) may use 4 32-point FFT tone plans (with 2 existing pilot tones) or two existing 64-point FFT tone plans (e.g., the pilot tone plan 270) to create 8 pilot tone locations. If 8 STAs are to be supported with 2 pilots each, the DSSP pilot tone plan 280 may be copied twice to generate a tone plan with 16 pilot tone locations. An example of a tone plan for a 128-point FFT is shown in FIG. 3C, infra.

In another configuration, a 256-point FFT may be used with a 20 MHz symbol having a 4 symbol duration (e.g., 12.8 μs), a 40 MHz symbol having a 2 symbol duration, or an 80 MHz symbol having a 1 symbol duration. In this configuration, the tone plan already has 8 pilots to support up to 4 STAs with 2 pilots each. To support 8 STAs, 8 32-point FFTs may be used or 4 existing 64-point FFT tone plans (e.g., the pilot tone plan 270) may be used to create 16 pilot tone locations.

In another configuration, a 512-point FFT may be used with a 40 MHz symbol having a 4 symbol duration or an 80 MHz symbol having a 2 symbol duration. In this configuration, the existing tone plan already has 16 pilot tones to support up to 8 STAs with 2 pilots each.

In yet another configuration, a 1024-point FFT may be used with an 80 MHz symbol having a 4 symbol duration. In this configuration, a tone plan with 16 pilot tones may be used to support 8 STAs with 2 pilots for each STA.

FIGS. 3A-3B are diagrams for allocating dedicated single stream pilot tones. FIG. 3A illustrates a pilot tone plan 300 for a 64-point FFT (e.g., a pilot tone plan implemented in IEEE 802.11ac and the pilot tone plan 270). As seen in FIG. 3A, the pilot tone plan 300 has 4 pilot tones 302, 304, 306, 308 located on tone indices −21, −7, 7, and 21. However, the pilot tone plan 300 may not be enough to support DSSP for 4 or more STAs.

FIG. 3B illustrates an example of a DSSP tone plan 330 for a 64-point FFT that supports up to 4 STAs. In the DSSP tone plan 330, 4 additional pilot tones have been inserted to the existing 4 pilot tones from the pilot tone plan 300 in FIG. 3A to arrive at a total of 8 pilot tones 332, 334, 336, 338, 340, 342, 344, 346. The pilot tone locations in the DSSP tone plan 330 have been slightly adjusted so that the pilot tones are spread evenly over the entire bandwidth. As such, the pilot tone 332 is located on tone index −23, the pilot tone 334 is located on tone index −17, the pilot tone 336 is located on tone index −11, the pilot tone 338 is located on tone index −5, the pilot tone 340 is located on tone index 5, the pilot tone 342 is located on tone index 11, the pilot tone 344 is located on tone index 17, and the pilot tone 346 is located on tone index 23. To support 4 STAs, the dedicated set of pilot tones 332, 340 may be allocated to a first STA, the dedicated set of pilot tones 334, 342 may be allocated to a second STA, the dedicated set of pilot tones 336, 344 may be allocated to a third STA, and the dedicated set of pilot tones 338, 346 may be allocated to a fourth STA.

FIG. 3C illustrates an example of a second DSSP tone plan 360 for a 128-point FFT that supports up to 8 STAs. In one aspect, the second DSSP tone plan 360 can be generated by mirroring the DSSP tone plan 330 twice (e.g., the second DSSP tone plan 360 may consist of two of the DSSP tone plans 330). The pilot tone locations in the second DSSP tone plan 360 have been adjusted so that the pilot tones are spread evenly over the entire bandwidth and symmetric around tone index 0. Similar to FIG. 3B, each of the pilot tones 362, 364, 366, 368, 370, 372, 374, 376, 378, 380, 382, 384, 386, 388, 390, 392 is located in a respective tone index. To support 8 STAs with 2 pilot tones each, the dedicated set of pilot tones 362, 378 may be allocated to a first STA, the dedicated set of pilot tones 364, 380 may be allocated to a second STA, the dedicated set of pilot tones 366, 382 may be allocated to a third STA, the dedicated set of pilot tones 368, 374 may be allocated to a fourth STA, the dedicated set of pilot tones 370, 386 may be allocated to a fifth STA, the dedicated set of pilot tones 372, 388 may be allocated to a sixth STA, the dedicated set of pilot tones 374, 390 may be allocated to a seventh STA, and the dedicated set of pilot tones 376, 392 may be allocated to an eighth STA. In FIGS. 3A-3B, the tone indices −1, 0, and 1 may correspond to direct current locations. The aforementioned DSSP tone plans may be used for LTF symbols (e.g., HE LTF symbols) and/or data symbols to support 4 to 8 STAs (or users).

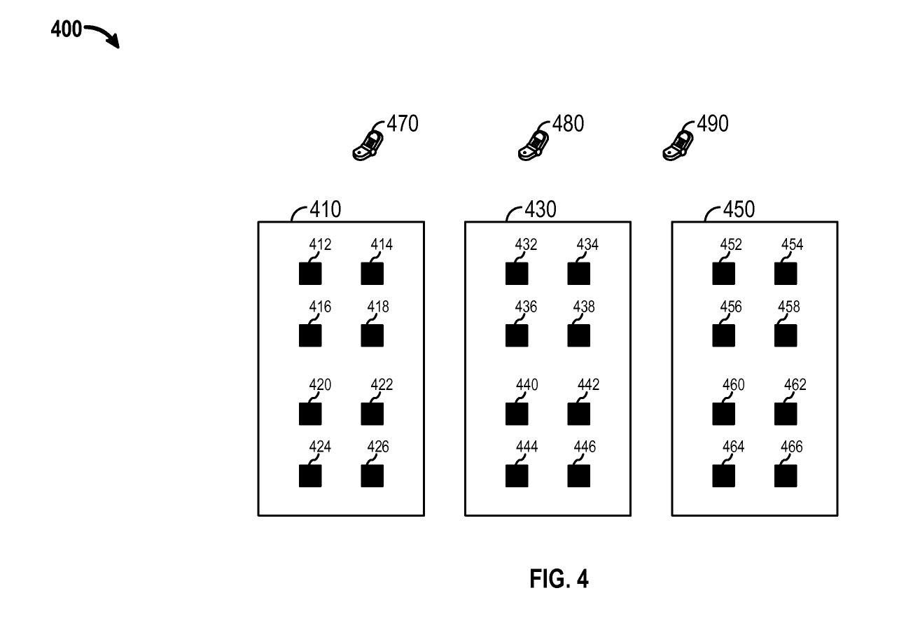

FIG. 4 is a diagram 400 for allocating dedicated single stream pilot tones. In some instances, the total number of pilots may be fixed at an even number for a given bandwidth (e.g., FIGS. 3A-B). Under such circumstances, the total number of tones may not be easily divided amongst an odd number of STAs. For example, in a 20 MHz symbol having a 4 symbol duration, the tone plan has 8 pilot tones (e.g., symbol 410). Assuming there are 3 STAs, within each symbol, two STAs may be allocated 3 pilot tones, but one STA would only be allocated 2 pilot tones. One solution to this problem is to have a tone plan that supports a maximum number of STAs, and a fixed number of pilot tones per STA. If the actual number of STAs is smaller, this leaves unused pilot tones in the tone plan. For example, in the case of 8 pilot tones being split between 3 STAs, each STA would have 2 pilot tones and the remaining 2 pilot tones would remain unallocated. This method of allocation may be applied in DSSP tone plans (e.g., the DSSP tone plan 330, the second DSSP tone plan 360) and non-DSSP tone plans (e.g., the pilot tone plan 270 and the pilot tone plan 300). Another solution, so-called a mini-walking pilot scheme, is illustrated in FIG. 4. As shown in FIG. 4, there are three STAs 470, 480, 490 and three symbols 410, 430, 450. Each of the three symbols 410, 430, 450 has a fixed number of pilot tones-that is, 8 pilot tones in each symbol, for a total of 24 pilot tones among the three symbols 410, 430, 450. The 24 pilot tones may be shared among the three STAs 470, 480, 490. In sharing the 24 pilot tones, the total number of pilots allocated per STA is the same over a period of time (e.g., 3 LTF symbols). For example, in the symbol 410, the STA 470 may be allocated a dedicated set of pilot tones 412, 414, the STA 480 may be allocated a dedicated set of pilot tones 416, 418, 420, 422, and the STA 490 may be allocated a dedicated set of pilot tones 424, 426. In symbol 430, the STA 470 may be allocated a dedicated set of pilot tones 436, 438, 440, 442, the STA 480 may be allocated a dedicated set of pilot tones 444, 446, the STA 490 may be allocated a dedicated set of pilot tones 432, 434. In symbol 450, the STA 470 may be allocated a dedicated set of pilot tones 464, 466, the STA 480 may be allocated a dedicated set of pilot tones 452, 454, and the STA 490 may be allocated a dedicated set of pilot tones 456, 458, 460, 462. In other words, the STAs 470, 480, 490 may share the pilot tones in the symbols 410, 430, 450 in a rotational fashion or scheme so that over a period of time, any STA gets an equal fractional number of pilots for phase tracking. Although each of the STAs 470, 480, 490 may be allocated a different pilot tone position in each of the symbols 410, 430, 450, the set of pilot tones allocated to each STA over a period of time for the three symbols 410, 430, 450 may remain the same. For example, the dedicated set of pilot tones 412, 414, 436, 438, 440, 442, 464, 466 allocated to the STA 470 may remain the same. This method allows for greater frequency diversity in case some of the pilot locations encounter deep fading. With this scheme, a fixed number of pilot tones may be reserved in the data symbol (or LTF symbol) for phase tracking, and the number of pilot tones need not be divisible by odd numbers. This method may be used with a DSSP tone plan or non-DSSP tone plans. In one aspect, the STAs may be able to determine which pilot tones to utilize at a certain point in time based on the STA's identity within the group of STAs.

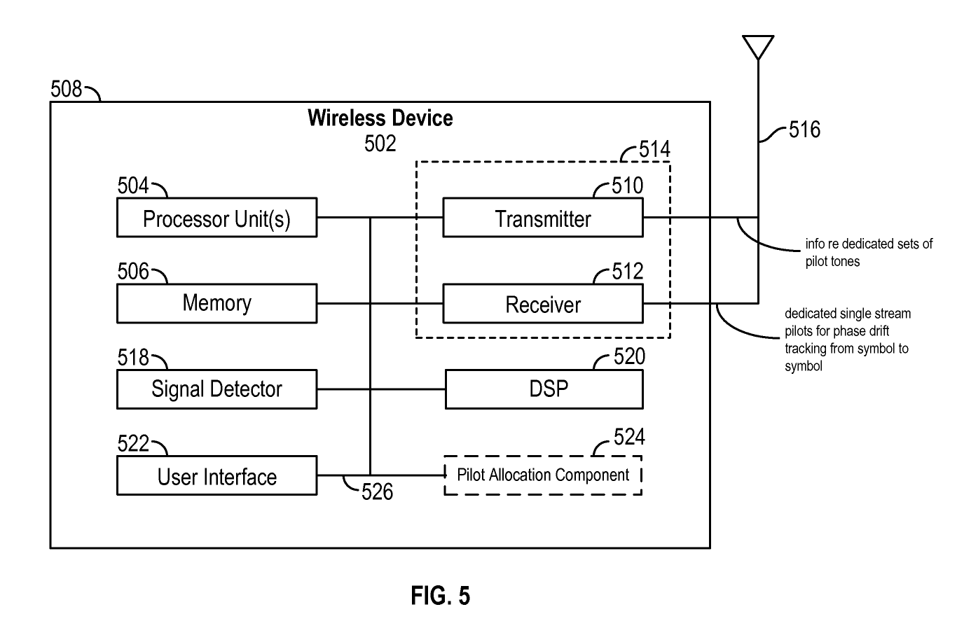

FIG. 5 is a functional block diagram of a wireless device 502 that may be employed within the wireless communication system 100 of FIG. 1 to allocate dedicated single stream pilots for phase tracking The wireless device 502 is an example of a device that may be configured to implement the various methods described herein. For example, the wireless device 502 may be the AP 104 or the AP 202.

The wireless device 502 may include a processor 504 which controls operation of the wireless device 502. The processor 504 may also be referred to as a central processing unit (CPU). Memory 506, which may include both read-only memory (ROM) and random access memory (RAM), may provide instructions and data to the processor 504. A portion of the memory 506 may also include non-volatile random access memory (NVRAM). The processor 504 typically performs logical and arithmetic operations based on program instructions stored within the memory 506. The instructions in the memory 506 may be executable (by the processor 504, for example) to implement the methods described herein.

The processor 504 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 502 may also include a housing 508, and the wireless device 502 may include a transmitter 510 and/or a receiver 512 to allow transmission and reception of data between the wireless device 502 and a remote device. The transmitter 510 and the receiver 512 may be combined into a transceiver 514. An antenna 516 may be attached to the housing 508 and electrically coupled to the transceiver 514. The wireless device 502 may also include (not shown) multiple transmitters, multiple receivers, multiple transceivers, and/or multiple antennas.

The wireless device 502 may also include a signal detector 518 that may be used to detect and quantify the level of signals received by the transceiver 514 or the receiver 512. The signal detector 518 may detect such signals as total energy, energy per subcarrier per symbol, power spectral density, and other signals. The wireless device 502 may also include a DSP 520 for use in processing signals. The DSP 520 may be configured to generate a packet for transmission. In some aspects, the packet may comprise a physical layer convergence protocol (PLCP) protocol data unit (PPDU).

The wireless device 502 may further comprise a user interface 522 in some aspects. The user interface 522 may comprise a keypad, a microphone, a speaker, and/or a display. The user interface 522 may include any element or component that conveys information to a user of the wireless device 502 and/or receives input from the user.

When the wireless device 502 is implemented as an AP (e.g., AP 104, AP 202), the wireless device 502 may also comprise a pilot allocation component 524. The pilot allocation component 524 may be configured to allocate dedicated sets of pilot tones to a plurality of stations to enable per station phase drift tracking from symbol to symbol. Each station of the plurality of stations is allocated a dedicated set of pilot tones and each dedicated set of pilot tones is used to transmit dedicated single stream pilots. The pilot allocation component 524 may be configured to transmit, via the transmitter 510 or the transceiver 514, information indicating the allocated and dedicated sets of pilot tones to the plurality of stations. The frame may include information indicating the allocated and dedicated sets of pilot tones used for transmitting dedicated single stream pilots. In one configuration, the frame may include information indicating an order in which each station of the plurality of stations has been allocated the dedicated sets of pilot tones. The pilot allocation component 524 may be configured to receive, via the receiver 512 or the transceiver 514, a plurality of dedicated single stream pilots from the plurality of stations. In one configuration, the pilot allocation component 524 may be configured to determine the phase drift for each station of the plurality of stations by comparing a first phase of a first dedicated single stream pilot located on a first symbol with a second phase of a second dedicated single stream pilot located on a second symbol. In another configuration, the pilot allocation component 524 may be configured to receive, from each station, a first and a second dedicated single stream pilots located on a first symbol and a third and a fourth dedicated single stream pilots located on a second symbol. In this configuration, the pilot allocation component 524 may be configured to determine the phase drift by determining, for each station of the plurality of stations, a first difference between a first phase of the first dedicated single stream pilot located on the first symbol and a second phase of the third dedicated single stream pilot located on the second symbol, and by determining, for each station of the plurality of stations, a second difference between a third phase of the second dedicated single stream pilot located on the first symbol and a fourth phase of the fourth dedicated single stream pilot located on the second symbol. Further in this configuration, the pilot allocation component 524 may be configured to average, for each station of the plurality of stations, the first difference and the second difference to estimate a phase drift. In one configuration, the dedicated sets of pilot tones are located within at least one of a set of LTF symbols or a set of data symbols. In another configuration, each dedicated set of pilot tones has at least two pilot tones allocated to each station of the plurality of stations. In another configuration, each station of the plurality of stations has a fixed number of allocated pilot tones within a symbol. In another configuration, each station of the plurality of station has a same number of allocated pilot tones in a period. In another configuration, each dedicated set of pilot tones may have two pilot tones allocated to each station of the plurality of stations, the pilot allocation component 524 may be configured to reserve a number of pilot tones for the plurality of stations, and the number of pilot tones may be at least twice a total number of stations in the plurality of stations.

The various components of the wireless device 502 may be coupled together by a bus system 526. The bus system 526 may include a data bus, for example, as well as a power bus, a control signal bus, and a status signal bus in addition to the data bus. Components of the wireless device 502 may be coupled together or accept or provide inputs to each other using some other mechanism.

Although a number of separate components are illustrated in FIG. 5, one or more of the components may be combined or commonly implemented. For example, the processor 504 may be used to implement not only the functionality described above with respect to the processor 504, but also to implement the functionality described above with respect to the signal detector 518, the DSP 520, the user interface 522, and/or the pilot allocation component 524. Further, each of the components illustrated in FIG. 5 may be implemented using a plurality of separate elements.

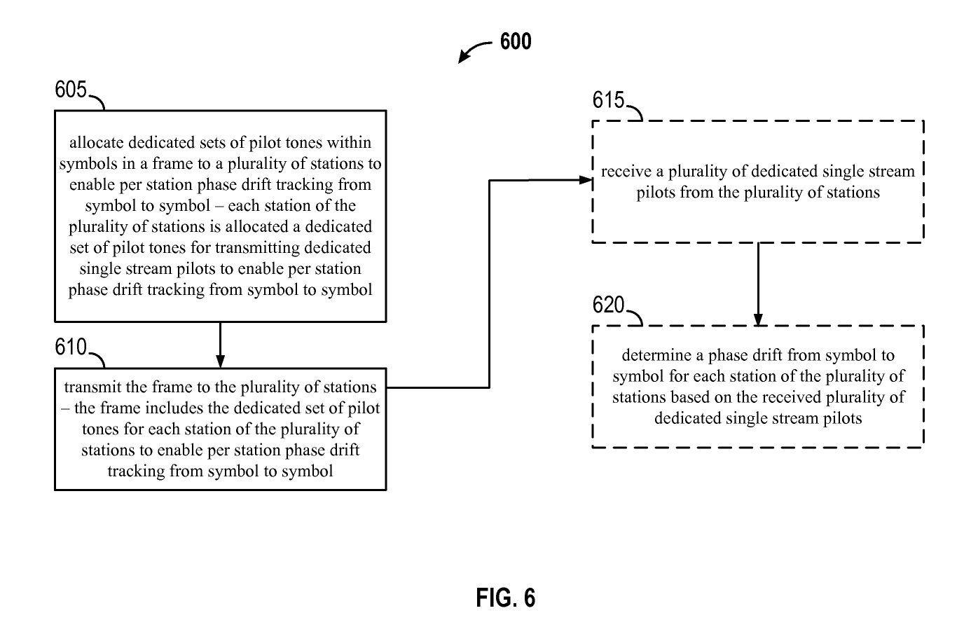

FIG. 6 is a flowchart of an exemplary method 600 of wireless communication for dedicated single stream pilot allocation and phase tracking The method 600 may be performed using an apparatus (e.g., the AP 104, the AP 202, or the wireless device 502, for example). Although the method 600 is described below with respect to the elements of wireless device 502 of FIG. 5, other components may be used to implement one or more of the steps described herein.

At block 605, the apparatus may allocate dedicated sets of pilot tones to a plurality of stations to enable per station phase drift tracking from symbol to symbol, and each station of the plurality of stations may be allocated a dedicated set of pilot tones. Each dedicated set of pilot tones may be used to transmit dedicated single stream pilots. For example, referring to FIG. 2, the AP 202 may allocate dedicated sets of pilot tones (pilot tones 282, 290 (set one), pilot tones 284, 292 (set two), pilot tones 286, 294 (set three), pilot tones 288, 296 (set four)) to each of the STAs 206, 210, 212, 214. The pilot tones 282, 290 may be used by the STA 206 to transmit dedicated single stream pilots. Because the pilot tones 282, 290 are dedicated, other STAs may not use the pilot tones 282, 290.

At block 610, the apparatus may transmit a frame to the plurality of stations. The frame may include information indicating the allocated and dedicated sets of pilot tones used for transmitting dedicated single stream pilots. In one configuration, the frame may include information indicating an order in which each station of the plurality of stations has been allocated the dedicated sets of pilot tones. In another configuration, the dedicated sets of pilot tones are located within at least one of a set of LTF symbols or a set data symbols. In another configuration, each dedicated set of pilot tones has at least two pilot tones allocated to each station of the plurality of stations. In another configuration, each station of the plurality of stations has a fixed number of allocated pilot tones within a symbol. In another configuration, each station of the plurality of stations has a same number of allocated pilot tones in a period. In yet another configuration, when each dedicated set of pilot tones has two pilot tones allocated to each station of the plurality of stations, the apparatus may be configured to allocate the dedicated sets of pilot tones by reserving a number of pilot tones for the plurality of stations in which the number is at least twice a total number of stations in the plurality of stations. For example, the AP 202 may transmit a frame 204 to STAs 206, 210, 212, 214. The frame 204 may indicate that STA 206 has been allocated two pilot tones, the pilot tones 282, 290. The frame 204 may indicate that the STA 206 has been allocated set one of four sets of pilot tones in LTF symbols or data symbols. In this example, the pilot tones 282, 290 may be located in the LTF symbols 260. In this example, each of the STAs 206, 210, 212, 214 has been allocated 2 pilot tones.

At block 615, the apparatus may be configured to receive a plurality of dedicated single stream pilots from the plurality of stations. For example, the AP 202 may receive, from the STA 206, dedicated single stream pilots 208 on the pilot tones 282, 290. The AP 202 may receive, from the other STAs 210, 212, 214, dedicated single streams pilots on the remaining, respective pilot tones.

At block 620, the apparatus may determine a phase drift for each station of the plurality of stations based on the received plurality of dedicated single stream pilots. In one configuration, the apparatus may determine a phase drift by comparing a first phase of a first dedicated single stream pilot located on a first symbol with a second phase of a second dedicated single stream pilot located on a second symbol. In another configuration, the apparatus may receive, from each station, a first and a second dedicated single stream pilots located on a first symbol and a third and a fourth dedicated single stream pilots located on a second symbol. The apparatus may determine the phase drift by, determining, for each station of the plurality of stations, a first difference between a first phase of the first dedicated single stream pilot located on the first symbol and a second phase of the third dedicated single stream pilot located on the second symbol, and determining, for each station of the plurality of stations, a second difference between a third phase of the second dedicated single stream pilot located on the first symbol and a fourth phase of the fourth dedicated single stream pilot located on the second symbol. In this configuration, the apparatus may, for each station of the plurality of stations, average the first difference and the second difference to estimate a phase drift. In one example, the AP 202, having received the dedicated single stream pilots 208 from the STA 206, may compare a first phase of a first dedicated single stream pilot transmitted on the pilot tone 282 on LTF1 with a second phase of a second dedicated single stream pilot transmitted on the pilot tone 282 on LTF2. The phase drift may be estimated as the difference between the first and the second phase. In another configuration, the STA may also compare a first phase of a first dedicated single stream pilot transmitted on the pilot tone 290 on LTF1 with a second phase of a second dedicated single stream pilot transmitted on the pilot tone 290 on LTF2. The phase drift may be estimated based on both differences in phases from the DSSPs received in LTF1 and LTF2. In another example, the AP 202, having received the dedicated single stream pilots 208 from the STA 206, may determine a first difference between a first phase of a first dedicated single stream pilot transmitted on the pilot tone 282 on LTF1 and a second phase of a second dedicated single stream pilot transmitted on the pilot tone 282 on LTF2. The AP 202 may also determine a second difference between a third phase of a third dedicated single stream pilot transmitted on the pilot tone 290 on LTF1 and a fourth phase of a fourth dedicated single stream pilot transmitted on the pilot tone 290 on LTF2. The AP 202 may average the first and second differences to estimate a phase drift in the LTF symbols of the STA 206.

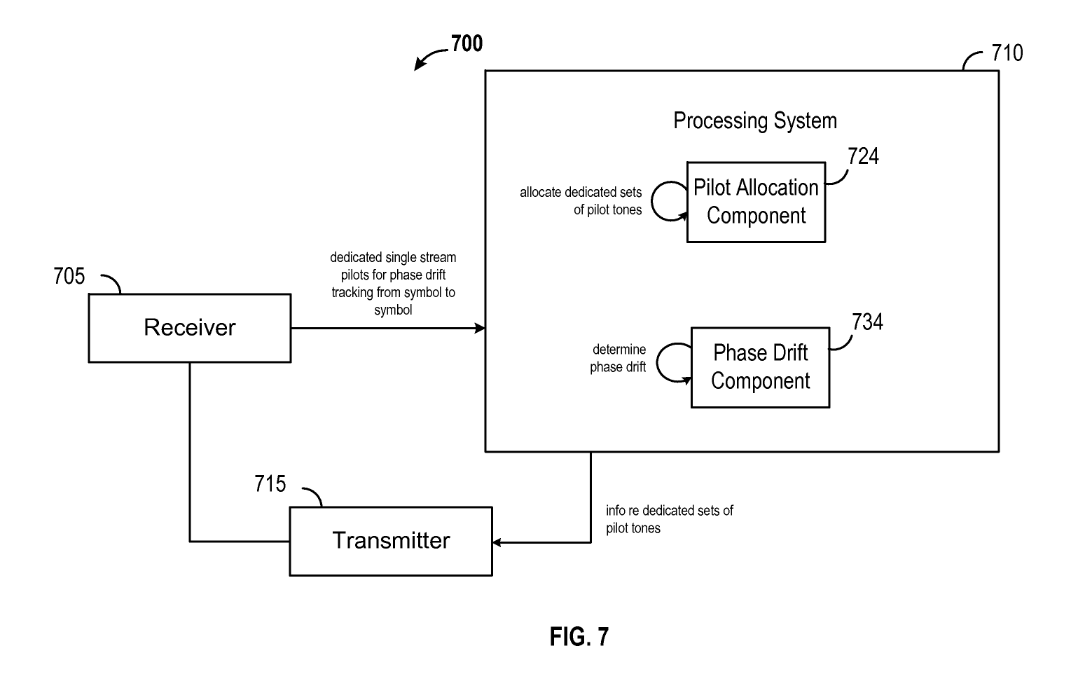

FIG. 7 is a functional block diagram of an exemplary wireless communication device 700 for dedicated single stream pilot allocation and phase tracking The wireless communication device 700 may include a receiver 705, a processing system 710, and a transmitter 715. The processing system 710 may include a pilot allocation component 724 and/or a phase drift component 734. The processing system 710 and/or the pilot allocation component 724 may be configured to allocate dedicated sets of pilot tones to a plurality of stations to enable per station phase drift tracking from symbol to symbol. Each station of the plurality of stations may be allocated a dedicated set of pilot tones and each dedicated set of pilot tones is used to transmit dedicated single stream pilots. The processing system 710, the pilot allocation component 724, and/or the transmitter 715 may be configured to transmit a frame to the plurality of stations. The frame may include information indicating the allocated and dedicated sets of pilot tones used for transmitting dedicated single stream pilots. The frame may include information indicating an order in which each station of the plurality of stations has been allocated the dedicated sets of pilot tones. The dedicated sets of pilot tones may be located within at least one of a set of LTF symbols or a set data symbols. Each dedicated set of pilot tones may have at least two pilot tones allocated to each station of the plurality of stations. Each station of the plurality of stations may have a fixed number of allocated pilot tones within a symbol. Each station of the plurality of stations may have a same number of allocated pilot tones in a period. When each dedicated set of pilot tones has two pilot tones allocated to each station of the plurality of stations, the processing system 710 and/or the pilot allocation component 724 may be configured to allocate the dedicated sets of pilot tones by reserving a number of pilot tones for the plurality of stations. The number may be at least twice a total number of stations in the plurality of stations. The processing system 710, the pilot allocation component 724, and or the receiver 705 may be configured to receive a plurality of dedicated single stream pilots from the plurality of stations. The processing system 710, the pilot allocation component 724, and/or the phase drift component 734 may be configured to determine a phase drift for each station of the plurality of stations based on the received plurality of dedicated single stream pilots.

The receiver 705, the processing system 710, the pilot allocation component 724, and/or the transmitter 715 may be configured to perform one or more functions discussed above with respect to blocks 605, 610, 615, and 620 of FIG. 6. The receiver 705 may correspond to the receiver 512. The processing system 710 may correspond to the processor 504. The transmitter 715 may correspond to the transmitter 510. The pilot allocation component 724 may correspond to the pilot allocation component 124 and/or the pilot allocation component 524.

Moreover, means for allocating dedicated sets of pilot tones to a plurality of stations may comprise the processing system 710 and/or the pilot allocation component 724. Means for transmitting a frame to the plurality of stations may comprise the processing system 710, the pilot allocation component 724, and/or the transmitter 715. Means for receiving a plurality of dedicated single stream pilots from the plurality of stations may comprise the processing system 710, the pilot allocation component 724, and/or the receiver 705. Means for determining a phase drift for each station of the plurality of stations based on the received plurality of dedicated single stream pilots may comprise the processing system 710 and/or the pilot allocation component 724.

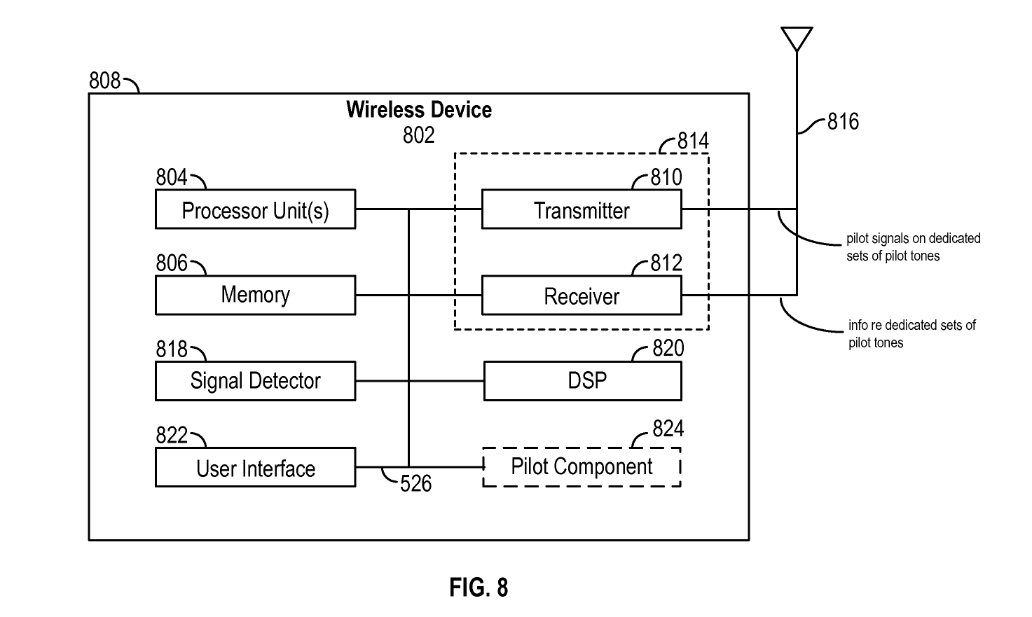

FIG. 8 is a functional block diagram of a wireless device 802 that may be employed within the wireless communication system 100 of FIG. 1 for transmitting dedicated single stream pilot for phase tracking The wireless device 802 is an example of a device that may be configured to implement the various methods described herein. For example, the wireless device 802 may be the STA 114 or the STAs 206, 210, 212, 214.

The wireless device 802 may include a processor 804 which controls operation of the wireless device 802. The processor 804 may also be referred to as a CPU. Memory 806, which may include both ROM and RAM, may provide instructions and data to the processor 804. A portion of the memory 806 may also include NVRAM. The processor 804 typically performs logical and arithmetic operations based on program instructions stored within the memory 806. The instructions in the memory 806 may be executable (by the processor 804, for example) to implement the methods described herein.

The processor 804 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 802 may also include a housing 808, and the wireless device 802 may include a transmitter 810 and/or a receiver 812 to allow transmission and reception of data between the wireless device 802 and a remote device. The transmitter 810 and the receiver 812 may be combined into a transceiver 814. An antenna 816 may be attached to the housing 808 and electrically coupled to the transceiver 814. The wireless device 802 may also include (not shown) multiple transmitters, multiple receivers, multiple transceivers, and/or multiple antennas.

The wireless device 802 may also include a signal detector 818 that may be used to detect and quantify the level of signals received by the transceiver 814 or the receiver 812. The signal detector 818 may detect such signals as total energy, energy per subcarrier per symbol, power spectral density, and other signals. The wireless device 802 may also include a DSP 820 for use in processing signals. The DSP 820 may be configured to generate a packet for transmission. In some aspects, the packet may comprise a PPDU.

The wireless device 802 may further comprise a user interface 822 in some aspects. The user interface 822 may comprise a keypad, a microphone, a speaker, and/or a display. The user interface 822 may include any element or component that conveys information to a user of the wireless device 802 and/or receives input from the user.

When the wireless device 802 is implemented as an STA (e.g., STA 114, STA 206), the wireless device 802 may also include a pilot component 824. The pilot component 824 may be configured to receive a frame from an access point. The frame may include information that indicates a dedicated set of pilot tones allocated to the wireless device 802 to enable phase drift tracking from symbol to symbol. The pilot component 824 may be configured to transmit to the access point, via the transmitter 810 or the transceiver 814, dedicated single stream pilots on the dedicated set of pilot tones based on the received information. The dedicated set of pilot tones are located within at least one of a set of LTF symbols or a set of data symbols. The frame may include information indicating an order in which the wireless device 802 has been allocated the dedicated set of pilot tones. In one configuration, the pilot component 824 may be configured to determine the dedicated set of pilot tones allocated to the wireless device 802 based on the information included in the frame. In another aspect, the dedicated set of pilot tones includes at least two pilot tones. In another aspect, the station is allocated a fixed number of pilot tones within a symbol.

The various components of the wireless device 802 may be coupled together by a bus system 826. The bus system 826 may include a data bus, for example, as well as a power bus, a control signal bus, and a status signal bus in addition to the data bus. Components of the wireless device 802 may be coupled together or accept or provide inputs to each other using some other mechanism.

Although a number of separate components are illustrated in FIG. 8, one or more of the components may be combined or commonly implemented. For example, the processor 804 may be used to implement not only the functionality described above with respect to the processor 804, but also to implement the functionality described above with respect to the signal detector 818, the DSP 820, the user interface 822, and/or the pilot component 824. Further, each of the components illustrated in FIG. 8 may be implemented using a plurality of separate elements.

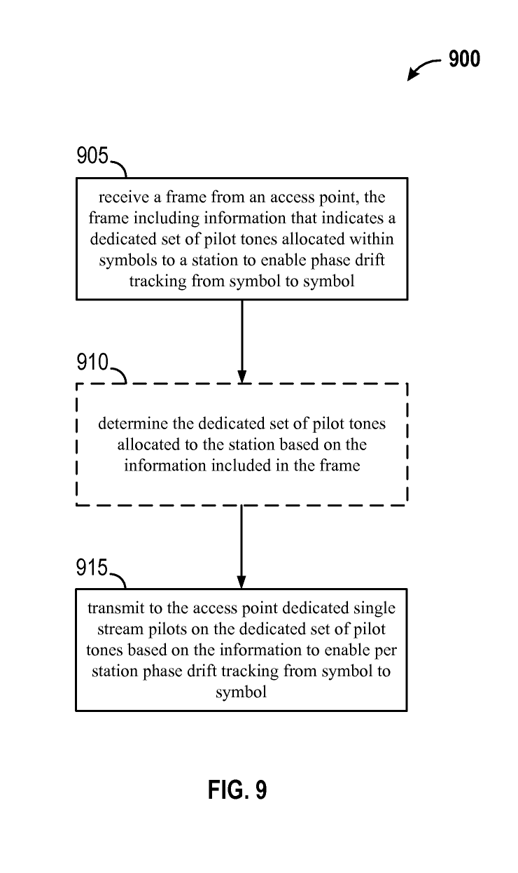

FIG. 9 is a flowchart of an example method 900 of wireless communication for transmitting dedicated single stream pilot for phase tracking The method 900 may be performed using an apparatus (e.g., the STA 114, the STA 206, or the wireless device 802, for example). Although the method 900 is described below with respect to the elements of wireless device 802 of FIG. 8, other components may be used to implement one or more of the steps described herein.

At block 905, the apparatus may receive a frame from an access point. The frame may include information that indicates a dedicated set of pilot tones allocated to the apparatus to enable phase drift tracking from symbol to symbol. The frame may include information indicating an order in which the apparatus has been allocated the dedicated set of pilot tones. The dedicated set of pilot tones may be located within at least one of a set of LTF symbols or a set of data symbols. For example, referring to FIG. 2, the STA 206 may receive a frame 204 from the AP 202. The frame may include information that indicates a dedicated set of pilot tones 282, 290 has been allocated to the STA 206. The frame may include information indicating that the STA 206 has been allocated the first set of dedicated pilot tones of four sets of dedicated pilot tones, and the pilot tones 282, 290 may be located in the LTF symbols 260.

At block 910, the apparatus may determine the dedicated set of allocated pilot tones for the apparatus based on the information included in the frame. For example, the STA 206 may determine that the pilot tones 282, 290 correspond to set one, the pilot tones 284, 292 correspond to set two, the pilot tones 286, 294 correspond to set three, and the pilot tones 288, 296 correspond to set four. The ordering information may indicate that the STA 206 has been allocated set one and/or the STA 206 has been allocated the pilot tones 282, 290.

At block 915, the apparatus may transmit to the access point dedicated single stream pilots on the dedicated set of pilot tones based on the received information. For example, the STA 206 may transmit to the AP 202 dedicated single stream pilots 208 on the dedicated set of pilot tones 282, 290 based on the received information in the frame 204.

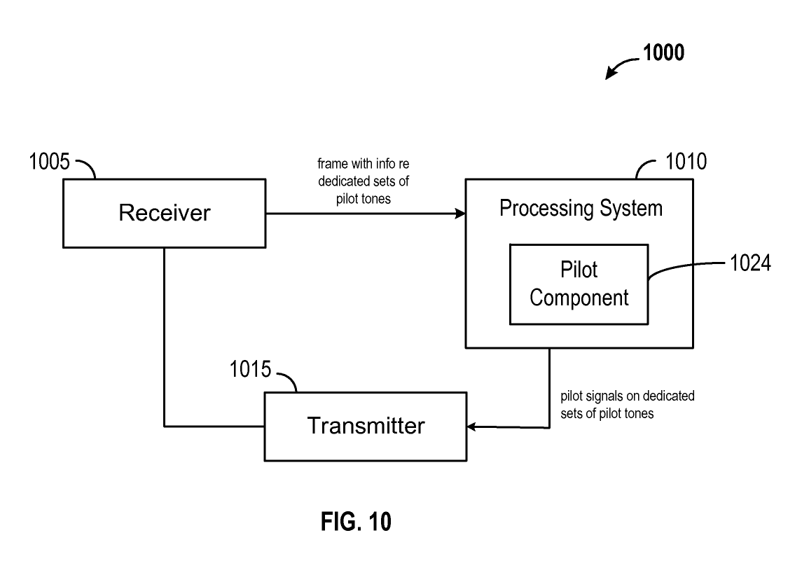

FIG. 10 is a functional block diagram of an exemplary wireless communication device 1000 for transmitting dedicated single stream pilot for phase tracking The wireless communication device 1000 may include a receiver 1005, a processing system 1010, and a transmitter 1015. The processing system 1010 may include a pilot component 1024. The processing system 1010, the pilot component 1024, and/or the receiver 1005 may be configured to receive a frame from an access point. The frame may include information indicating a dedicated set of pilot tones has been allocated to the wireless communication device 1000. The frame may include information indicating an order in which the wireless communication device 1000 has been allocated the dedicated set of pilot tones. The dedicated set of pilot tones may be located within at least one of a set of LTF symbols or a set of data symbols. The processing system 101 and/or the pilot component 1024 may be configured to determine the dedicated set of pilot tones allocated to the wireless communication device 1000 based on the information included in the frame. The processing system 1010, the pilot component 1024, and/or the transmitter 1015 may be configured to transmit to the access point dedicated single stream pilots on the dedicated set of pilot tones based on the information.

The receiver 1005, the processing system 1010, the pilot component 1024, and/or the transmitter 1015 may be configured to perform one or more functions discussed above with respect to blocks 905, 910, and 915 of FIG. 9. The receiver 1005 may correspond to the receiver 812. The processing system 1010 may correspond to the processor 804. The transmitter 1015 may correspond to the transmitter 810. The pilot component 1024 may correspond to the pilot component 126 and/or the pilot component 824.

Moreover, means receiving a frame from an access point may comprise the processing system 1010, the pilot component 1024, and/or the receiver 1005. Means for determining the dedicated set of pilot tones may comprise the processing system 1010 and/or the pilot component 1024. Means for transmitting to the access point dedicated single stream pilots on the dedicated set of pilot tones based on the information may comprise the processing system 1010, the pilot component 1024, and/or the transmitter 1015.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of operating an access point, comprising:
allocating dedicated sets of pilot tones within symbols to a plurality of stations to enable per station phase drift tracking from symbol to symbol, wherein each station of the plurality of stations is allocated a dedicated set of pilot tones for transmitting dedicated single stream pilots to enable per station phase drift tracking from symbol to symbol, wherein phase drift tracking is different from channel estimation; and
transmitting a frame to the plurality of stations, wherein the frame includes information indicating the allocated and dedicated sets of pilot tones used for transmitting dedicated single stream pilots to enable per station phase drift tracking from symbol to symbol, wherein phase drift tracking is different from channel estimation.

2. The method of claim 1, wherein the frame further includes information indicating an order in which each station of the plurality of stations has been allocated the dedicated sets of pilot tones that enable phase drift tracking from symbol to symbol.

3. The method of claim 1, further comprising:
receiving a plurality of dedicated single stream pilots from the plurality of stations; and
determining a phase drift from symbol to symbol for each station of the plurality of stations based on the received plurality of dedicated single stream pilots.

4. The method of claim 3, wherein the receiving comprises receiving, from each station, a first and a second dedicated single stream pilots located on a first symbol and a third and a fourth dedicated single stream pilots located on a second symbol, and
wherein the determining the phase drift comprises:
for each station of the plurality of stations, determining a first difference between a first phase of the first dedicated single stream pilot located on the first symbol and a second phase of the third dedicated single stream pilot located on the second symbol, and determining a second difference between a third phase of the second dedicated single stream pilot located on the first symbol and a fourth phase of the fourth dedicated single stream pilot located on the second symbol; and
for each station of the plurality of stations, averaging the first difference and the second difference.

5. The method of claim 1, wherein the dedicated sets of pilot tones are located within at least one of a set of long training field (LTF) symbols or a set data symbols, and the dedicated set of pilot tones enables multi-user (MU) multiple-input-multiple-output (MIMO) phase drift tracking from symbol to symbol.

6. The method of claim 1, wherein each dedicated set of pilot tones has at least two pilot tones allocated to each station of the plurality of stations.

7. The method of claim 1, wherein each station of the plurality of stations has a fixed number of allocated pilot tones within a symbol.

8. The method of claim 1, wherein each station of the plurality of stations has a same number of allocated pilot tones in a period.

9. The method of claim 1, wherein each dedicated set of pilot tones has two pilot tones allocated to each station of the plurality of stations, and the allocating the dedicated sets of pilot tones comprises reserving a number of pilot tones for the plurality of stations, the number being at least twice a total number of stations in the plurality of stations.

10. An apparatus for wireless communication, comprising:
a memory; and
at least one processor coupled to the memory and configured to:
allocate dedicated sets of pilot tones within symbols to a plurality of stations to enable per station phase drift tracking from symbol to symbol, wherein each station of the plurality of stations is allocated a dedicated set of pilot tones for transmitting dedicated single stream pilots to enable per station phase drift tracking from symbol to symbol, wherein phase drift tracking is different from channel estimation; and
transmit a frame to the plurality of stations, wherein the frame includes information indicating the allocated and dedicated sets of pilot tones used for transmitting dedicated single stream pilots to enable per station phase drift tracking from symbol to symbol, wherein phase drift tracking is different from channel estimation.

11. The apparatus of claim 10, wherein the frame further includes information indicating an order in which each station of the plurality of stations has been allocated the dedicated sets of pilot tones that enable phase drift tracking from symbol to symbol.

12. The apparatus of claim 10, wherein the at least one processor is further configured to:
receive a plurality of dedicated single stream pilots from the plurality of stations; and
determine a phase drift from symbol to symbol for each station of the plurality of stations based on the received plurality of dedicated single stream pilots.

13. The apparatus of claim 12, wherein the at least one processor is configured to receive the plurality of dedicated single stream pilots by receiving, from each station, a first and a second dedicated single stream pilots located on a first symbol and a third and a fourth dedicated single stream pilots located on a second symbol, and
wherein the at least one processor is configured to determine the phase drift by:
determining, for each station of the plurality of stations, a first difference between a first phase of the first dedicated single stream pilot located on the first symbol and a second phase of the third dedicated single stream pilot located on the second symbol, and determining, for each station of the plurality of stations, a second difference between a third phase of the second dedicated single stream pilot located on the first symbol and a fourth phase of the fourth dedicated single stream pilot located on the second symbol; and
averaging, for each station of the plurality of stations, the first difference and the second difference.

14. The apparatus of claim 10, wherein the dedicated sets of pilot tones are located within at least one of a set of long training field (LTF) symbols or a set data symbols, and the dedicated set of pilot tones enables multi-user (MU) multiple-input-multiple-output (MIMO) phase drift tracking from symbol to symbol.

15. The apparatus of claim 10, wherein each dedicated set of pilot tones has at least two pilot tones allocated to each station of the plurality of stations.

16. The apparatus of claim 10, wherein each station of the plurality of stations has a fixed number of allocated pilot tones within a symbol.

17. The apparatus of claim 10, wherein each station of the plurality of stations has a same number of allocated pilot tones in a period.

18. The apparatus of claim 10, wherein each dedicated set of pilot tones has two pilot tones allocated to each station of the plurality of stations, the at least one processor is configured to reserve a number of pilot tones for the plurality of stations, the number being at least twice a total number of stations in the plurality of stations.

19. A method of operating a station, comprising:
receiving a frame from an access point, the frame including information that indicates a dedicated set of pilot tones allocated within symbols to the station for transmitting dedicated single stream pilots to enable phase drift tracking from symbol to symbol, wherein phase drift tracking is different from channel estimation; and
transmitting to the access point the dedicated single stream pilots on the dedicated set of pilot tones based on the information to enable per station phase drift tracking from symbol to symbol, wherein phase drift tracking is different from channel estimation.

20. The method of claim 19, wherein the dedicated set of pilot tones is located within at least one of a set of long training field (LTF) symbols or a set of data symbols, and the dedicated set of pilot tones enables phase drift tracking from symbol to symbol.

21. The method of claim 19, wherein the frame further includes information indicating an order in which the station has been allocated the dedicated set of pilot tones.

22. The method of claim 19, further comprising determining the dedicated set of pilot tones allocated to the station based on the information included in the frame.

23. The method of claim 19, wherein the dedicated set of pilot tones includes at least two pilot tones.

24. The method of claim 19, wherein the station is allocated a fixed number of pilot tones within a symbol.

25. An apparatus for wireless communication, the apparatus being a station and comprising:
a memory; and
at least one processor coupled to the memory and configured to:
receive a frame from an access point, the frame including information that indicates a dedicated set of pilot tones allocated within symbols to the station for transmitting dedicated single stream pilots to enable phase drift tracking from symbol to symbol, wherein phase drift tracking is different from channel estimation; and
transmit to the access point dedicated single stream pilots on the dedicated set of pilot tones based on the information to enable per station phase drift tracking from symbol to symbol, wherein phase drift tracking is different from channel estimation.

26. The apparatus of claim 25, wherein the dedicated set of pilot tones are located within at least one of a set of long training field (LTF) symbols or a set of data symbols, and the dedicated set of pilot tones enables phase drift tracking from symbol to symbol.

27. The apparatus of claim 25, wherein the frame further includes information indicating an order in which the station has been allocated the dedicated set of pilot tones.

28. The apparatus of claim 25, wherein the at least one processor is further configured to determine the dedicated set of pilot tones allocated to the station based on the information included in the frame.

29. The apparatus of claim 25, wherein the dedicated set of pilot tones includes at least two pilot tones.

30. The apparatus of claim 25, wherein the station is allocated a fixed number of pilot tones within a symbol.
